(19) United States
(12) Patent Application Publication
(10) Pub. No.: US 2006/0031258 A1
(43) Pub. Date: Feb. 9, 2006

(54) System and method for matching traveling companions with traveling acquaintances

(76) Inventor: Debra Seed, Schomberg (CA)

Correspondence Address: Elias C. Borges, Suite 406, 555 Burnhamthorpe Road, Toronto, ON, M9C 2Y3, CA

(21) Appl. No.: 11/182,825

(22) Filed: Jul. 18, 2005

Related U.S. Application Data
(60) Provisional application No. 60/599,038, filed on Aug. 6, 2004.

(51) Int. Cl. G06F 17/00

(52) U.S. Cl. 707/104.1

(57) ABSTRACT

The present invention is a system for matching over the internet a plurality like-minded individuals to travel. The system includes a server operatively coupled to the internet, the server having a web site and web server application thereon and a database application operatively coupled to the web server application. The database application is configured to permit travelers to perform web queries on the database. The database contains a traveler section having a plurality of traveler records. Each traveler record includes a name field, a gender field, an age field, a destination field and a travel date field corresponding to the name, gender, age, preferred travel destination and travel availability dates of each traveler, respectively. The web site on the server has at least one traveler input page to permit travelers to log into the page and input their name, gender, age, preferred destination and travel availability dates, the input page being coupled to the database so as to update the corresponding fields of the database. The web site on the server also has at least one traveler query page coupled to the database, the traveler query page having a plurality of search query parameter fields namely a gender field, an age range field, a preferred destination field and a travel availability date field, wherein the traveler can enter the preferred gender, age range, destination and travel dates of a traveling companion the traveler is searching for. Finally, the query page has a search button which upon activation, activates the database application to conduct a query search of the traveler section of the database for travelers meeting the search parameters, the web server and database application being adapted and configured to display the results of the search on a search results web page.

### CROSS REFERENCE TO RELATED APPLICATION

This application claims priority from U.S. provisional patent application No. 60/599,038 filed Aug. 6, 2004, the entirety of which is incorporated herein by reference.

### BACKGROUND OF THE INVENTION

The vacation travel industry is a multi-billion dollar industry in North America. Traditionally, when a person desired to take a travel vacation, they would attend at the offices of a local travel agent and consult with them concerning a potential vacation. The travel agent would then present to the client a various vacation packages. These packages would range from fully inclusive vacations at various resorts to ship cruises to straight air-fair to and from a particular location and are always quoted in double occupancy.

A significant new trend in travel today is the rising importance of the single individual wishing to take a trip. The single individual is a trend set by aging baby boomers, divorced people, and widowed individuals. In the past, most vacations were taken either by couples or by small groups of singles. These small groups of singles usually consisted of a group of friends or family members who wished to travel. However, in recent years an increasingly large group of single people find themselves with the time, financial resources and desire to take vacations. An increasingly large number of these single people find themselves without a friend or family member to travel with. Since traveling on vacation can be intimidating to many people, many single people with the resources and desire to travel choose not to. Travel agencies are not equipped to deal with this large pool of potential new clients since travel agents lack the ability to find willing traveling companions, travel acquaintances or travel friends. As a result a large potential market for vacation services has remained untapped.

### SUMMARY OF THE INVENTION

The present invention overcomes the drawbacks of the prior art by providing a system for matching over the internet a plurality like-minded individuals to travel. The system includes a server operatively coupled to the internet, the server having a web site and web server application thereon and a database application operatively coupled to the web server application. The database application is configured to permit travelers to perform web queries on the database. The database contains a traveler section having a plurality of traveler records. Each traveler record includes a name field, a gender field, an age field, a destination field and a travel date field corresponding to the name, gender, age, preferred travel destination and travel availability dates of each traveler, respectively. The web site on the server has at least one traveler input page to permit travelers to log into the page and input their name, gender, age, preferred destination and travel availability dates, the input page being coupled to the database so as to update the corresponding fields of the database. The web site on the server also has at least one traveler query page coupled to the database, the traveler query page having a plurality of search query parameter fields namely a gender field, an age range field, a preferred destination field and a travel availability date field, wherein the traveler can enter the preferred gender, age range, destination and travel dates of a traveling companion the traveler is searching for. Finally, the query page has a search button which upon activation, activates the database application to conduct a query search of the traveler section of the database for travelers meeting the search parameters, the web server and database application being adapted and configured to display the results of the search on a search results web page.

### DESCRIPTION OF THE DRAWINGS

FIG. 1. is a schematic representation of the system of the present invention.

FIG. 2. is a schematic representation of a query page in the web site portion of the present invention.

FIG. 3. is a schematic representation of the results page of a search conducted in the system shown in FIG. 1.

FIG. 4. is a schematic representation of an alternate results page of a search conducted in the system shown in FIG. 1.

FIG. 5. is a schematic representation of a profile page generated by the system.

FIG. 6. is a schematic representation of a destination page generated by the system.

FIG. 7. is a schematic representation of a data entry page in the web site portion of the present invention.

In the drawings like characters of reference indicate corresponding parts in the different figures.

### DETAILED DESCRIPTION OF THE INVENTION

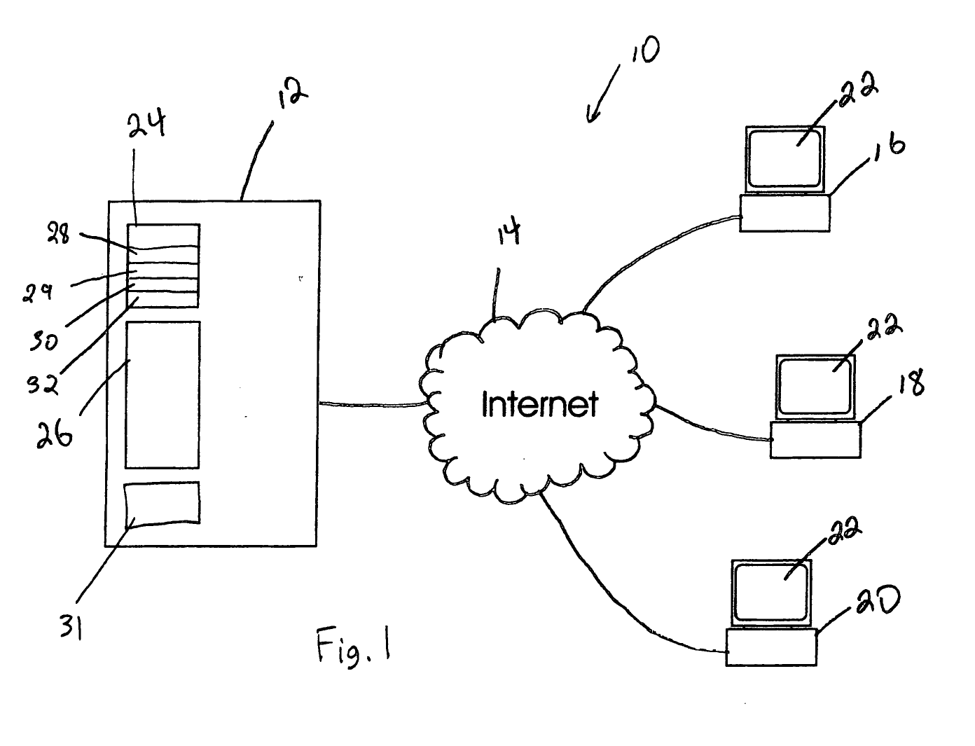

Referring to FIG. 1, the invention is a system for matching willing traveling companions with a travel acquaintance or a travel friend with similar interests or needs so that they can have a more enjoyable trip within an environment of like-minded individuals. It must be mentioned that the present system is not intended to match individuals for the purpose of romance or dating, but rather to match like-minded individuals wanting to travel with no strings attached.

Very often the individual traveler browses the internet with the desire to travel, but do not purchase a trip because they are alone and the single supplement is a deterrent. Rather than set up the usual online dating oriented service that would set up travelers with a potential companion based on romantic interest, this invention's only focus is connecting like-minded individuals that are looking for someone to accompany them on a trip so that they can have a more enjoyable trip with no strings attached. This invention will supply the travelers with a plurality of travel suppliers by significant affiliate advertisement associated with the travel industry only and will not include any online dating services. The invention will also include traveler's aid to provide health care professionals to those who require assistance to and from a destination. The system may also provide a travelers aid to assist caregivers of persons with Alzheimer's, assist cancer or other serious illnesses individuals that need assistance to travel. These care givers are matched with others who have similar circumstances and want to support, share and strengthen each other, through discussions and stories, as they travel. The system allows for matching families who have children or adults with special needs and are looking to travel together or meet in another part of the country or world. The system also enables the friendly transportation of students and graduates who would like to travel worldwide.

Referring firstly to FIG. 1, the system is intended to match individuals who wish to travel to the same destination with travel acquaintance or a travel friend with similar interests or needs so that they can have a more enjoyable trip within an environment of like-minded individuals. The system, shown generally as item 10 includes a server 12 operatively coupled to the Internet 14 and a plurality of users 16, 18 and 20 operatively coupled to the Internet. It will be appreciated that the system would include literally hundreds and indeed thousands of users; however, for the purposes of this explanation, a simplified system including only three users will be discussed. Server 12 is a web server optimized to host web site 24. Preferably, web server 12 will be running a web server application (not shown) and an appropriate operating system in order to ensure stable operation of web site 24. Web site 24 is operatively coupled to a database program 26. Database program 26 may be any relational database program suitable for running web based queries. Database program 26 may be resident on web server 12 or it may be resident on a back end server (not shown) depending on the architecture of the web hosting environment. Suitable database programs are readily available on the market.

Database 26 will contain a traveler section which includes information about people who wish to travel to particular destinations in the company of like-minded individual, traveling companions, a travel acquaintance or a travel friend. The information listed in the database for each person wishing to find a travel companion is stored as a record which includes fields relating to various features about the individuals preferred travel destination as well as various personal features of the individual them self. This information would include the preferred destination, the type of accommodation, the preferred time of travel, the age, gender, language and lifestyle of the traveler. Additional personal information concerning the individual may be contained in a profile filed which would include a short written statement describing the individual. The record may also include a picture file field of each individual. The information in database 26 is periodically updated so that it remains current.

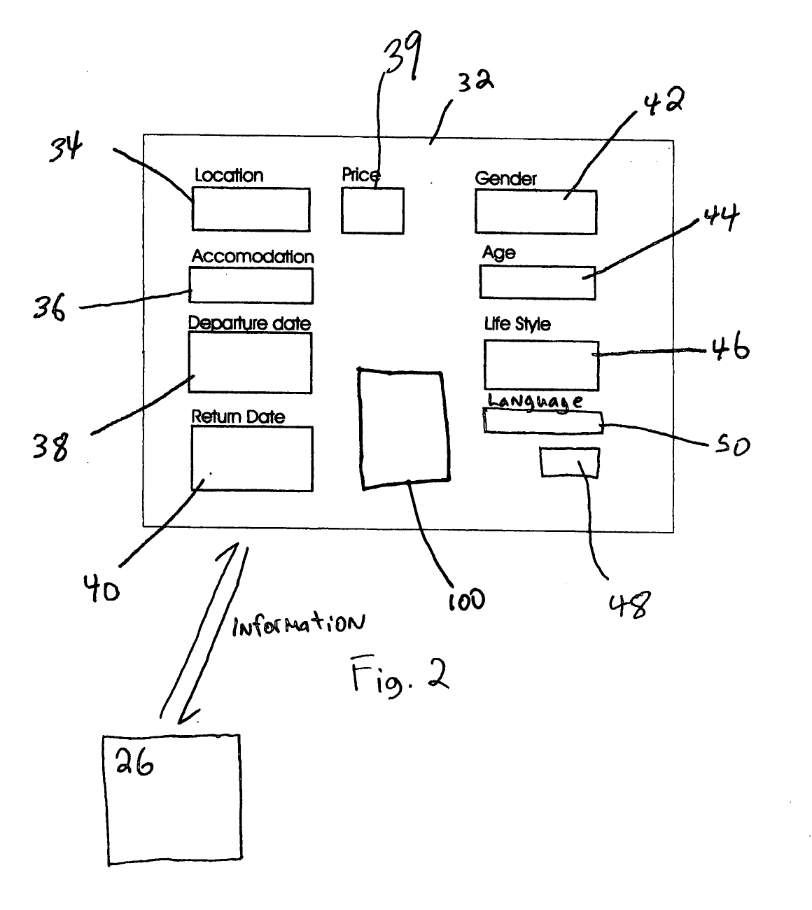

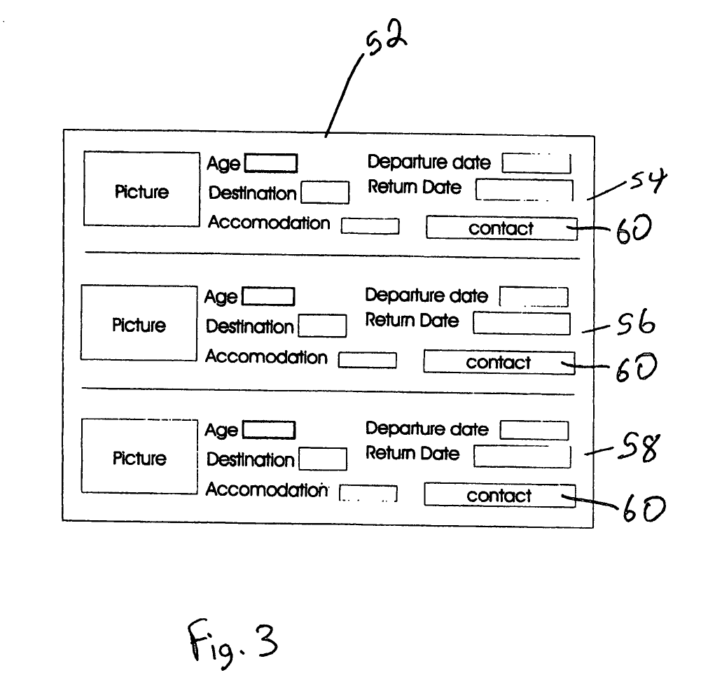

Web server 24 will have a plurality of pages 28, 29, 30 and 32. Some of these pages will include basic information about the web site, another would include registration information, wherein the user would register their name, address, telephone number and e-mail address with the operator of the web site and at least one page will include a vacation partner search option wherein users would be able to search for travel partners. One such search page is shown in FIG. 2. As seen in FIG. 2, the search page includes a plurality of fields 34 to 46 wherein the user either inputs data or selects data which is displayed. Web page 32 is operatively coupled to database 26 (see FIG. 1) such that page 32 displays information contained in database 26 and any information entered in the page is uploaded into database 26. Information is displayed and entered via fields 34 to 46. Fields 34 to 40 relate generally to the type of travel the user wishes to partake in, while fields 42 to 46 relate to the preferred travel companion which the user may wish to travel with. Search button 48 is provided on the web page. When search button 48 is engaged, a message is sent to database 26 to search through the database for a travel destination and or travel companion as specified in search parameter fields 34 to 48. To perform such a search, the user fills out as many of the search parameter fields as possible and then engages the “search button” 48 which causes the web page to signal database 26 to perform a search using the information contained in the various fields as the search parameters. The search results are then summarized in a results page 50 as seen in FIG. 3.

As mentioned previously, fields 34 to 39 relate to the actual vacation or travel which the user wishes to engage in. For example, location field 34 is preferably a scrolling list displaying a variety of travel destinations selected by other single travelers who have registered with the web site operator. The user may select one of the destinations displayed in field 34. Field 36 is a field wherein the user can select the type of accommodation which he or she desires. Preferably, field 36 consists of a scroll down list of the type of accommodation requested by the single traveler destination selected in field 34. Field 38 is a date field wherein the user enters his/her preferred departure date. Preferably, field 38 is in the form of a calendar which allows the user to simply select a date by highlighting it. Field 40 is similar to field 38 in that it is used to enable a user to select a preferred return date. Field 39 is the approximate price of the vacation selected in fields 34 to 40. Additional fields may be added to describe the nature of the travel products being offered through the web site. For example, fields may be added to describe cruises. In addition, links may be added to page 32 to enable the user to review the features and options present in each travel destination and/or accommodation.

Fields 42 to 50 are used to select the characteristics of the preferred travel companion. For example, field 42 displays the gender of the preferred travel companion (male, female or either). Field 44 displays the preferred age range of the travel companion. Field 46 describes the preferred life style or cultural background of the travel companion and field 50 describes the languages spoken by the preferred travel companion. The user selects from these fields a travel companion of the preferred gender, age, etc. before performing a search.

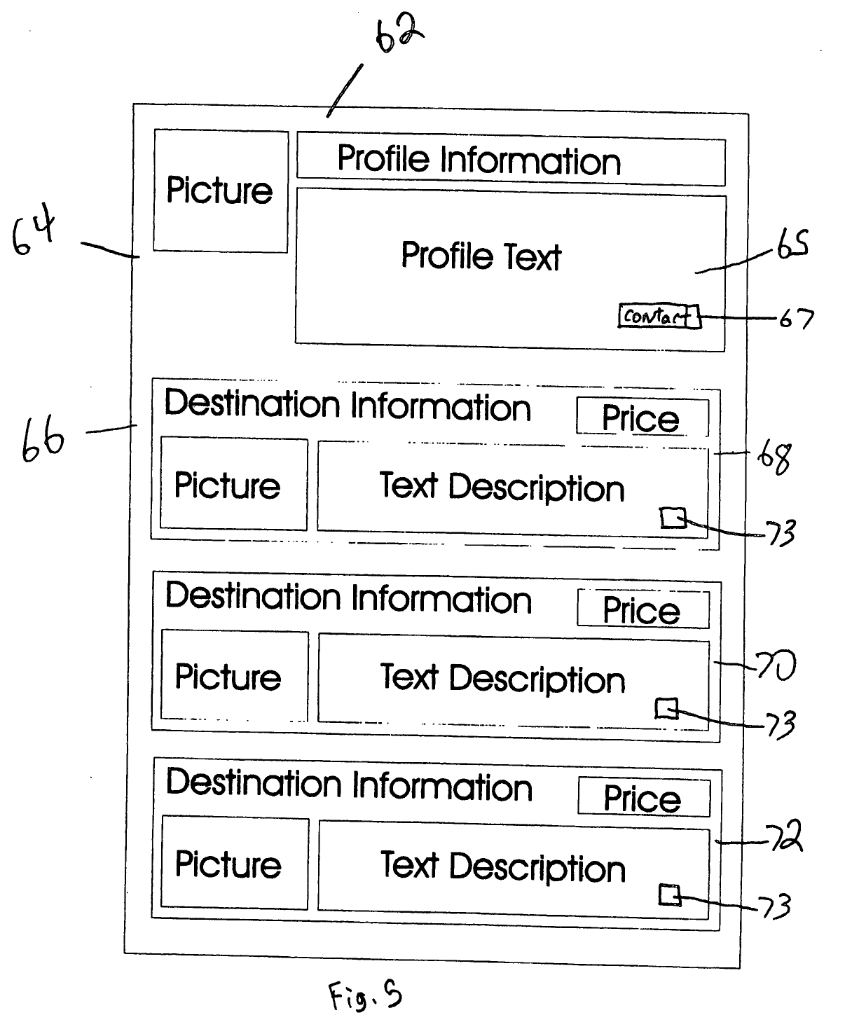

When the user has selected from all of the appropriate fields, he or she presses the “search button” 48 to commence a search of database 26. The database then performs a search of travel potential travel companions listed in the database which are traveling to the selected destination during the selected time interval and whom meet the personal characteristics selected by the user. The results of the search are displayed in results page 52 as seen in FIG. 3. FIG. 3 shows the results of a particular search for travel companions wishing to travel to a particular destination at a particular time. In this particular example, three individual travel companions are summarized in windows 54, 56 and 58. Each window displays a picture of the traveling companion (if available), as well as the companion's age and other personal characteristics and brief details about the preferred travel destination of each companion. Page 52 is set up as a summary page to summarize information concerning a plurality of different traveling companions. It will be understood that the database will contain much more detailed information about each travel companion. In order to provide the user with more information about a particular travel companion, each companion window is provided with a contact button 60, which links to a detailed companion page 62 as seen in FIG. 5.

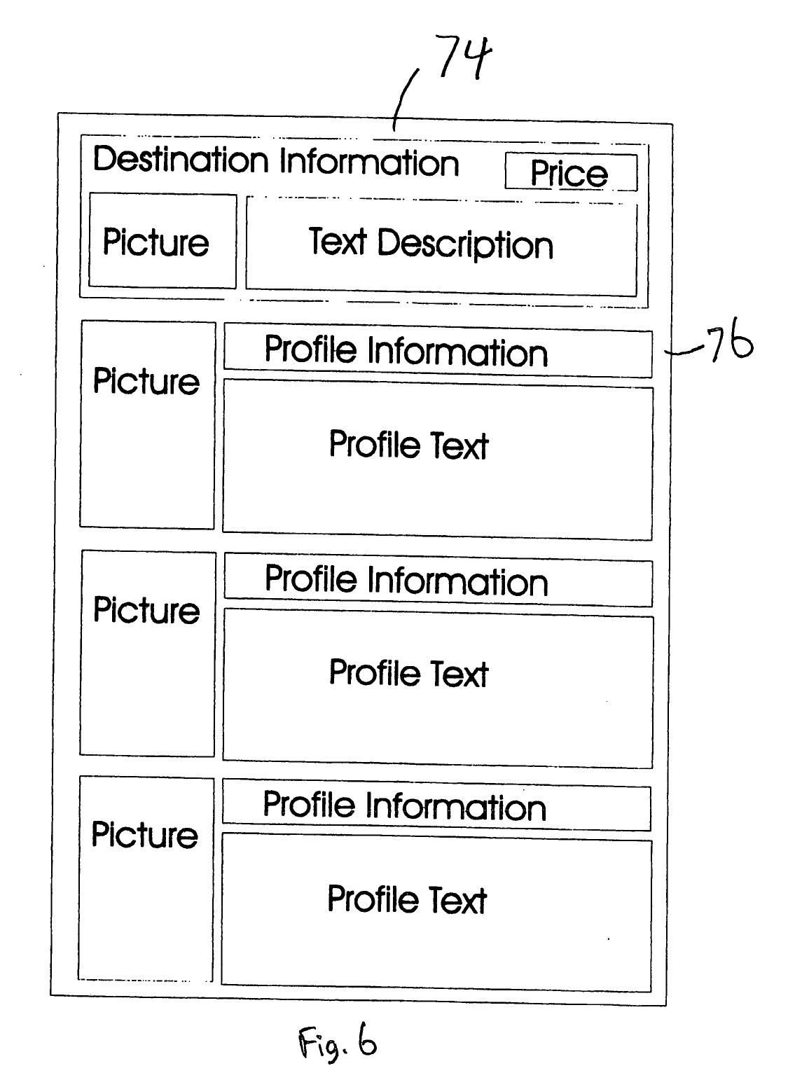

As seen in FIG. 5, the detailed companion page 62 contains two sections, a profile section 64 which contains detailed information about the selected companion and a destination summary section 66 containing a summary of the preferred destinations which that particular companion wishes to travel to. Profile section 64 will contain detailed information about the particular travel companion selected, including the companion's age, gender and the like. This information may also include an image of the travel companion as well as a brief written profile 65 written by the companion. Section 66 contains summary information about each destination which the travel companion wishes to travel to. In this example, the companion wishes to travel to three different destinations which are summarized in windows 68, 70 and 72. Preferably, each window would contain the name and location of the destination, the price of the destination package, a picture of the resort or hotel, a rating of the hotel or resort and a brief text description of destination. Each window would have a details button 73, which when activated would take the user's web browser to a destination summary page 74 as shown in FIG. 6.

As seen in FIG. 6, the destination summary page 74 will have detailed information concerning the destination selected, including a written description of the destination. Additional detailed information concerning the destination may also be listed. Page 74 may also have a travel companion summary section 76 wherein a number of different travel companions who have expressed a desire to travel to this destination are summarized. If the number of travel companions wishing to travel to the destination is large, then the travel companion summary section may contain a link to one or more companion summary pages.

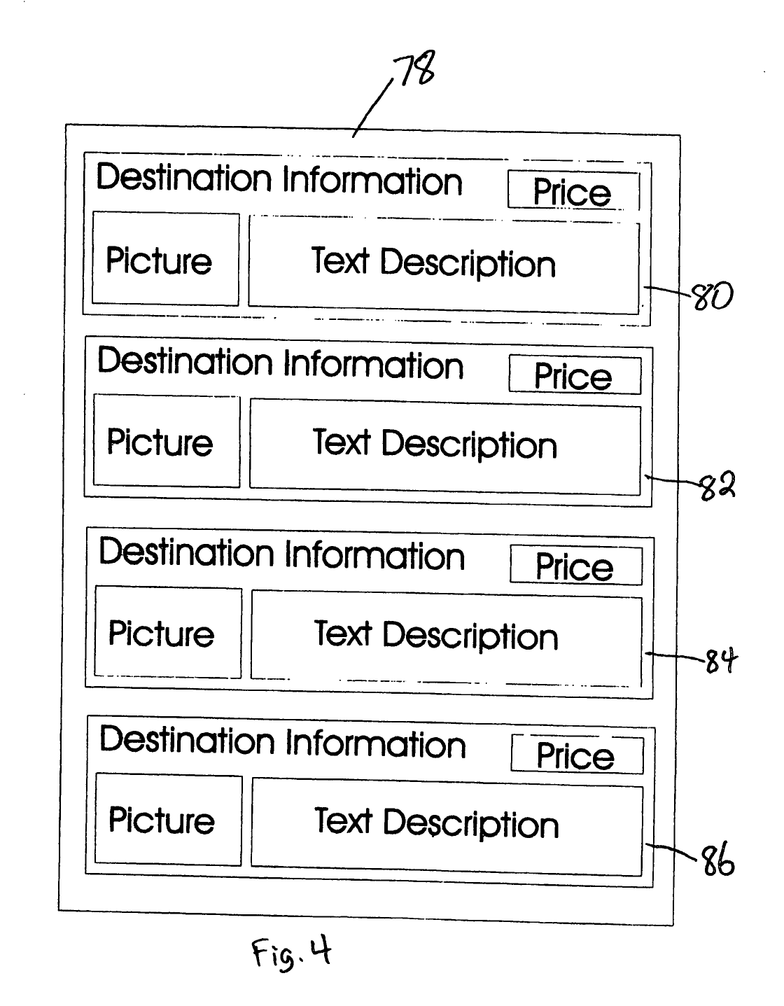

Referring back to FIG. 2, it is possible to configure database 26 such that the search results may be displayed as a list of destinations rather than travel companions. It will be appreciated, that many users wishing to find a travel companion might be more interested in the destination than the travel companion, and may therefore prefer to search through a list of destinations rather than companions. If so, database 26 can be configured to display the search results as a destination list page 78 as seen in FIG. 4. Destination list page 78 displays a list of destinations conforming to the user's search parameters. In the present example, page 78 lists four separate destinations/resorts in fields 80, 82, 84 and 86. Again, the user may select a particular destination from those listed in page 78 if the user wishes to obtain more detailed information about the destination and if the user wishes to learn which travel companions desire to travel to the selected destination, in which case the user would be taken to page 74 (FIG. 6).

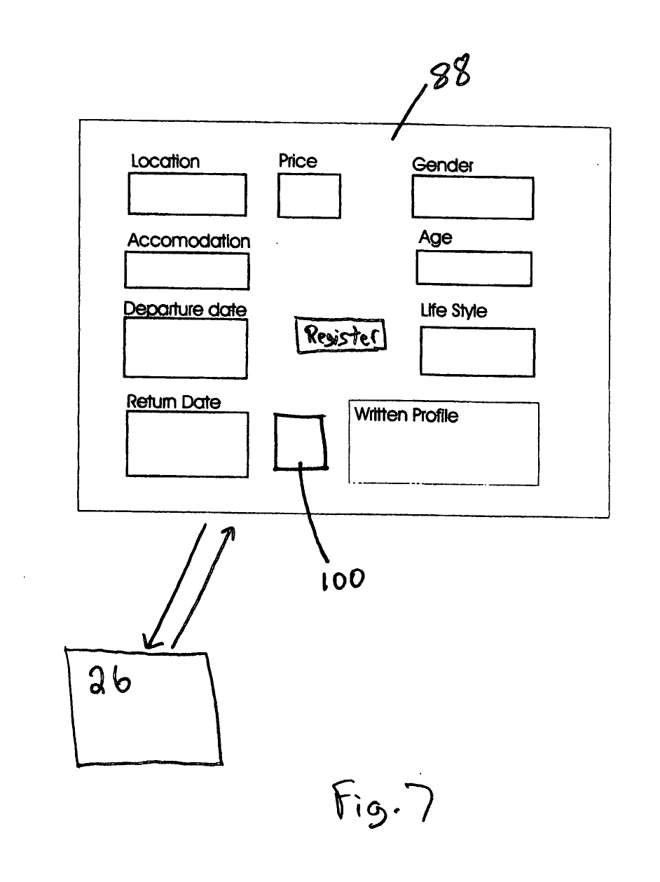

Referring now to FIG. 7, in order to perform any travel companion search on database 26, the database must be loaded with information concerning potential travel companions. The user may register himself/herself as a potential traveling companion by using a companion registration form 88. The user would enter in their preferred travel destination and time as well as their individual information such as their gender, age, language and the like. The user may also enter a short written description of themselves and their travel intentions (i.e. a profile). The user may also upload a picture of himself/herself. The user will also add contact information, such as the users phone number, address and e-mail address. When the information is filled in the form, the user may press a register button in order to transfer the data to database 26. Form 88 is very similar to the search form on page 32 (see FIG. 2). Web based database entry forms are well known in the prior art and several suitable examples can be found.

Referring back to FIG. 1, after the user has performed his or her searches and has settled on one or more potential travel companions, the user will wish to contact the travel companion(s) to get acquainted with the companions and settle the fine points of the trip. In order to protect the confidentiality of the travel companions, contact information is not displayed in the profile page 62; rather, each profile is provided with a contact button 67 (see FIG. 5). Web server 12 is provided with an internal messaging program 31 which is operatively coupled to database 26 and which is configured to permit users to send secure and confidential messages to each other. Upon engaging the contact button 67, messaging program 31 causes a message screen to appear on the users web browser window. The user may then type a detailed message in the message screen. The user's message may contain as much information about the user as the user likes, such as the users name and phone number, email address or the like. When the user is satisfied with the message, the user can activate a “send” button to send the message to the potential travel companion. When the send button is activated, the message written in the message screen is sent to messaging program 31, which then passes it on to either the companions email or to an internal message box for that companion. The companion may then respond directly to the user or may send back a reply via the internal messaging system. Internal messaging systems are well known in the art.

To provide users of the system with potentially useful information concerning suppliers of travel related products and services, such as tour operators, hotels, resorts, airlines, car rental companies and the like, the various web pages used in the system may contain display links 100 (see FIGS. 2 and 7). These display links could be advertisements for various suppliers or actual links to web sites operated by the suppliers.

The advantages of the present system are numerous. Firstly, the system provides a convenient and safe means for users to hook up with other users as traveling companions. Users may quickly find traveling companions whom are interested in the same sorts of destinations and who have compatible personal characteristics. In addition, the system provides an excellent medium for advertising of travel suppliers by significant affiliate advertisement associated with the travel industry of various vacation or travel destinations including hotels, resorts, airlines and car rental agencies.

I claim:

1. A system for matching over the internet a plurality of travelers comprising:
(a) a server operatively coupled to the internet, the server having a web site and web server application thereon, a database application operatively coupled to the web server application, the database application configured to perform web queries;
b) the database application having a database containing a traveler section, the traveler section having a plurality of traveler records, each record having a name field, a gender field, an age field, a destination field and a travel date field corresponding to the name, gender, age, preferred destination to travel to and travel availability dates of each traveler, respectively;
c) the web site on the server having at least one traveler input page adapted and configured to permit travelers to log into the page and input their name, gender, age, preferred destination and travel availability dates, the input page being coupled to the database so as to update the corresponding fields of the database;
d) the web site on the server having at least one traveler query page coupled to the database, the traveler query page having a plurality of search query parameter fields accessible by the traveler, namely a gender field, an age range field, a preferred destination field and a travel availability date field, wherein the traveler can enter the preferred gender, age range, destination to travel to and travel dates of a traveling companion the traveler is searching for, the query page having a search button which upon activation, activates the database application to conduct a query search of the traveler section of the database for travelers meeting the search parameters entered by the traveler, the web server and database application being adapted and configured to display the results of the searches on a search results web page.

2. The matching system of claim 1 further comprising a messenger service operatively coupled to the web server application, the messenger service being adapted and configured to permit travelers to contact each other.

3. The matching system of claim 1 wherein each traveler record further comprises a profile field containing a personal profile of the traveler corresponding to the record.

4. The matching system of claim 3 wherein each traveler record further comprises an image field containing an image of the traveler corresponding to the record.
